(19) United States
(12) Patent Application Publication
(10) Pub. No.: US 2015/0253129 A1
(43) Pub. Date: Sep. 10, 2015

(54) INSPECTION APPARATUS

(71) Applicant: OMRON Corporation, Kyoto-shi (JP)

(72) Inventor: Yasuhiro OHNISHI, Kyotanabe-shi (JP)

(21) Appl. No.: 14/626,971

(22) Filed: Feb. 20, 2015

(30) Foreign Application Priority Data
Mar. 6, 2014 (JP) 2014-043754

(51) Int. Cl. G01B 11/25

(52) U.S. Cl. CPC G01B 11/254; G01B 11/2531

(57) ABSTRACT

In an inspection apparatus having a projection device for projecting pattern light and an obliquely arranged camera, a technology is provided with which favorable measurement performance for measuring solder shapes is realized. If an illumination device is provided with openings for projection devices, then the openings are formed at azimuth directions that are from the X-axis direction and the Y-axis direction. If both an opening for a projection device and an opening for an obliquely arranged camera are provided, then they are arranged at different azimuth directions. Alternatively, it is also possible to provide a supplementary illumination device to supplement deficiencies in the illumination light due to the openings. Alternatively, it is also possible to match the optical axes of the projection device and the obliquely arranged camera and to provide a shared opening.

### FIELD

The present invention relates to an inspection apparatus for substrates onto which components are soldered.

### BACKGROUND

Inspection apparatuses are known that photograph a substrate after reflow with a camera, and inspect the quality of solder joints of components by analyzing the obtained image. In such an inspection apparatus, a methods is often used in which the solder surface is irradiated with red, green and blue illumination light from different angles of incidence, and by photographing the reflected light of the different colors with a camera, the three-dimensional shape of the solder fillets is visualized as two-dimensional color phase information (so-called color highlight system). Recently, there are also inspection apparatuses equipped with projection devices that project pattern light in order to measure three-dimensional shapes of diffuse objects (such as the height of the components themselves), in addition to illumination for measuring solder shapes (see JP 2011-149736A and JP 2013-221861A).

JP 2011-149736A and JP 2013-221861A are examples of related-art documents.

### SUMMARY

FIG. 12 schematically shows the configuration of an inspection apparatus disclosed in JP 2011-149736A. This inspection apparatus includes an illumination device for measuring solder shapes that is provided with three ring-shaped illuminations, namely a blue illumination 101B, a green illumination 101G and a red illumination 101R, and two projection devices 103 that are arranged to the left and right in X-axis direction. When measuring solder shapes, blue light B, green light G and red light R is irradiated onto a substrate 104 using the illuminations 101B, 101G and 101R, and the reflection light thereof is photographed by a camera 102 that is disposed on the Z-axis. And when measuring the height of components, striped pattern light L is projected from the projection devices 103 that are arranged to the left and right, and photographed with the camera 102.

The pattern light L must be projected from an oblique direction onto the substrate 104. Therefore, in the conventional device, the clearance between the ring-shaped illuminations 101B and 101G is large, as shown in FIG. 12, and the projection devices 103 are arranged between them, or, physical interference between the illumination device and the projection devices is avoided by forming openings for the pattern light projection halfway up the illumination device, as disclosed in JP 2013-221861A.

However, if the illumination device is provided with gaps or openings, then there are holes or gaps in the illumination light, as shown in FIG. 12, and there is the problem that the measurement performance for measuring solder shapes is decreased. In other words, to measure the inclinations of the solder fillet surfaces with high precision, it is preferable that there is a wide angular range in which the illumination light of the illumination device is continuous along the direction of the incidence angles (direction of the azimuth angles), and in the conventional device, a portion of the angular range of the illumination light is sacrificed for the pattern light projection.

The present invention was conceived in these circumstances and it is an object of the present invention to provide an inspection apparatus having a projection device for projecting pattern light with which a favorable measurement performance for measuring solder shapes is realized.

According to a first aspect of the present invention, an inspection apparatus having a camera for photographing a substrate onto which components are soldered from a direction orthogonal thereto is provided, wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises: an illumination device that is configured to illuminate the substrate from all azimuth directions with illumination light whose color or brightness changes stepwise or continuously depending on the zenith angle; one or more projection devices that are configured to project pattern light onto the substrate from a direction that is oblique with respect to the Z-axis; and a processing device that is configured to perform an inspection using an image of the substrate that is photographed with the camera in a state in which the illumination device is turned on or in a state in which pattern light is projected from the one or more projection devices; the one or more projection devices projecting the pattern light onto the substrate through one or more openings that are provided in the illumination device; and the one or more openings being provided at one or more azimuth directions that are different from both the X-axis direction and the Y-axis direction, as viewed from the point of origin.

According to a second aspect of the present invention, an inspection apparatus having a camera for photographing a substrate onto which components are soldered from a direction orthogonal thereto is provided, wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises: an illumination device that is configured to illuminate the substrate from all azimuth directions with illumination light whose color or brightness changes stepwise or continuously depending on the zenith angle; one or more projection devices that are configured to project through one or more openings in the illumination device pattern light onto the substrate from one or more directions that are oblique with respect to the Z-axis; a supplementary illumination device that irradiates the substrate with supplementary light that supplements deficiencies of the illumination light due to the one or more openings in the illumination device; and a processing device that is configured to perform an inspection using an image of the substrate that is photographed with the camera in a state in which the illumination device and the supplementary illumination device are turned on or in a state in which pattern light is projected from the one or more projection devices.

According to a third aspect of the present invention, an inspection apparatus having a camera for photographing a substrate onto which components are soldered from a direction orthogonal thereto is provided, wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises: an illumination device that is configured to illuminate the substrate from all azimuth directions with illumination light whose color or brightness changes stepwise or continuously depending on the zenith angle; one or more projection devices that are configured to project through one or more openings in the illumination device pattern light onto the substrate from one or more directions that are oblique with respect to the Z-axis; one or more obliquely arranged cameras that are configured to photograph the substrate through one or more openings in the illumination device from one or more directions that are oblique with respect to the Z-axis; and a processing device that is configured to perform an inspection using an image of the substrate that is photographed with the camera in a state in which the illumination device is turned on or in a state in which pattern light is projected from the one or more projection devices or an image of the substrate that is photographed with the one or more obliquely arranged cameras in a state in which the illumination device is turned on, the one or more openings for the projection devices being arranged at different azimuth directions, as viewed from the point of origin, from azimuth directions of the one or more openings for the obliquely arranged cameras.

According to a fourth aspect of the present invention, an inspection apparatus having a camera for photographing a substrate onto which components are soldered from a direction orthogonal thereto is provided, wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises: an illumination device that is configured to illuminate the substrate from all azimuth directions with illumination light whose color or brightness changes stepwise or continuously depending on the zenith angle; one or more projection devices that are configured to project through one or more openings in the illumination device pattern light onto the substrate from one or more directions that are oblique with respect to the Z-axis; one or more obliquely arranged cameras that are configured to photograph the substrate through one or more openings in the illumination device from one or more directions that are oblique with respect to the Z-axis; a processing device that is configured to perform an inspection using an image of the substrate that is photographed with the camera in a state in which the illumination device is turned on or in a state in which pattern light is projected from the one or more projection devices or an image of the substrate that is photographed with the one or more obliquely arranged cameras in a state in which the illumination device is turned on; and an optical member that is configured to match respective optical axes of the one or more projection devices with respective optical axes of the one or more obliquely arranged cameras, the openings for the one or more projection devices also serving as the openings for the one or more obliquely arranged cameras.

With the inspection apparatuses according to the above-described aspects, the influence that holes in the illumination light due to the openings for the projection devices and the openings for the obliquely arranged cameras have on the measurement of solder shapes can be made smaller than conventionally, and it is possible to realize a stable shape measurement.

In the inspection apparatuses according to any of the first to fourth aspects, the illumination device may have a dome-shaped light-emitting region, and at least in the four azimuth directions of the positive X-axis direction, the negative X-axis direction, the positive Y-axis direction, the negative Y-axis direction, the light-emitting region may be continuous from the smallest zenith angle to the largest zenith angle. Moreover, the illumination device may comprise a plurality of light-emitting bodies with different hue or brightness that are arranged at different zenith angles, and at least in the four azimuth directions of the positive X-axis direction, the negative X-axis direction, the positive Y-axis direction, and the negative Y-axis direction, the plurality of light-emitting bodies are lined up with substantially no gap between them. By using an illumination device with such a configuration, it is possible to measure with high precision the shape of the inclined surfaces of solder fillets that face the positive X-axis direction, the negative X-axis direction, the positive Y-axis direction, or the negative Y-axis direction.

In the inspection apparatuses according to any of the first to fourth aspects, taking an azimuth angle of the positive X-axis direction as 0 degrees, the one or more openings may be provided at about 45 degrees, about 135 degrees, about 225 degrees and/or about 315 degrees as viewed from the point of origin. By arranging the openings at azimuth directions that are furthest away from the X-axis direction and the Y-axis direction, it is possible to minimize the influence of the openings.

In the inspection apparatuses according to any of the first to fourth aspects, the inspection apparatus may include two projection devices, and an opening for one of the projection devices and an opening for the other of the projection devices may be arranged at azimuth directions that differ by 180 degrees, as viewed from the point of origin. Thus, it is possible to cover substantially all measurement objects on the substrate with only two projection devices.

The inspection apparatuses according to the first or second aspect preferably further comprises one or more obliquely arranged cameras that are configured to photograph the substrate through one or more openings in the illumination device from one or more directions that are oblique with respect to the Z-axis.

The above-described structures and functions can be combined into further aspects of the invention, as long as there is no technological contradiction.

With the present invention, it is possible to provide an inspection apparatus having a projection device for projecting pattern light with which a favorable measurement performance for measuring solder shapes can be realized.

### BRIEF DESCRIPTION OF THE DRAWINGS

FIG. 1A and FIG. 1 B are diagrams schematically showing the configuration of an inspection apparatus according to a first embodiment of the present invention.

FIG. 2 is a diagram schematically showing the configuration of an inspection apparatus according to a second embodiment of the present invention.

FIG. 3A and FIG. 3 B are diagrams schematically showing the configuration of an inspection apparatus according to a third embodiment of the present invention.

FIG. 4 is a diagram schematically showing the configuration of an inspection apparatus according to a fourth embodiment of the present invention.

FIG. 5 is a diagram schematically showing the configuration of an inspection apparatus according to a fifth embodiment of the present invention.

FIG. 6 is a diagram schematically showing the configuration of an inspection apparatus according to a sixth embodiment of the present invention.

FIG. 7 A and FIG. 7 B are diagrams schematically showing the configuration of an inspection apparatus according to a seventh embodiment of the present invention.

FIG. 8 is a diagram schematically showing the configuration of an inspection apparatus according to an eighth embodiment of the present invention.

FIG. 9 A and FIG. 9 B are diagrams schematically showing the configuration of an inspection apparatus according to a ninth embodiment of the present invention.

FIG. 10 is a diagram schematically showing components that are surface-mounted onto the substrate.

FIG. 11 is a diagram illustrating the coordinate system.

FIG. 12 is a diagram schematically showing the configuration of a conventional inspection apparatus.

### DETAILED DESCRIPTION

The present invention relates to visual substrate inspection apparatuses (referred to below simply as “inspection apparatuses”) for inspecting the quality of solder joints of a substrate to which components have been soldered (i.e. a substrate after reflow), and relates in particular to inspection apparatuses in which the arrangement of the camera, illumination device projection device and so on is optimized. The following is an explanation of preferable embodiments of the invention, with reference to the drawings.

FIG. 11 shows a coordinate system used for the explanation of the following embodiments and in the drawings. The intersection between the optical axis of the camera and a substrate that has been conveyed into the inspection apparatus and arranged at an inspection position is taken as the point of origin O. A direction that is parallel to a substrate surface (in particular the main substrate surface onto which the componentes are mounted) and parallel to a conveyance direction of the substrate is taken as the X-axis, a direction that is parallel to the substrate surface and orthogonal to the conveyance direction of the substrate is taken as the Y-axis, and a direction that is orthogonal to the substrate surface is taken as the Z-axis. The optical axis of the camera coincides with the Z-axis. Looking at a given point Q, the angle defined by the Z-axis and the line OQ through the point of origin O and the point Q is referred to as the zenith angle (φ), and the direction of the point Q within the XY-plane as viewed from the point of origin O is referred to as the azimuth angle or azimuth direction. When expressed as the azimuth angle (θ), the positive X-axis direction is taken as zero degrees, and going counterclockwise, the positive Y-axis direction is taken as 90 degrees, the negative X-axis direction is taken as 180 degrees, and the negative Y-axis direction is taken as 270 degrees.

### First Embodiment

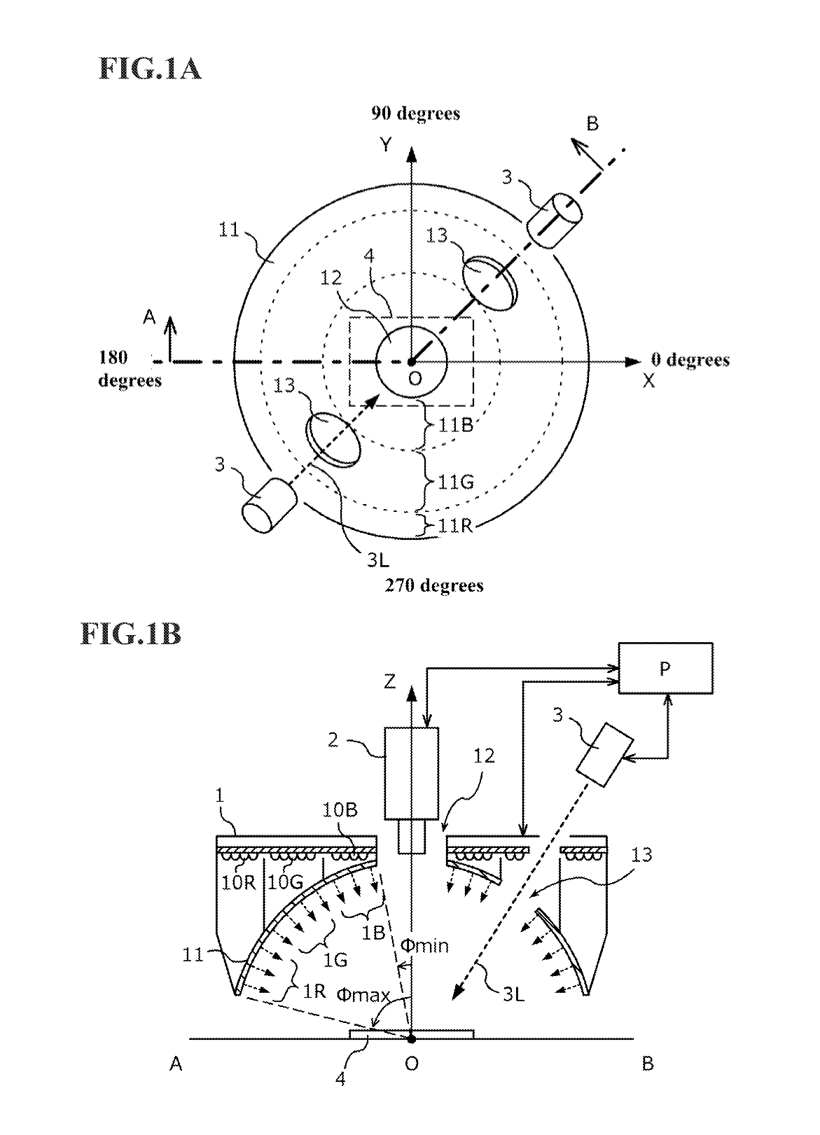

FIG. 1 A and FIG. 1 B are diagrams schematically showing the configuration of an inspection apparatus according to a first embodiment of the present invention. FIG. 1A shows the arrangement of an illumination device and projection devices, taken from the z-axis zenith, and FIG. 1B is a combined cross-sectional view along the line AOB (dash-dotted line) of FIG. 1A.

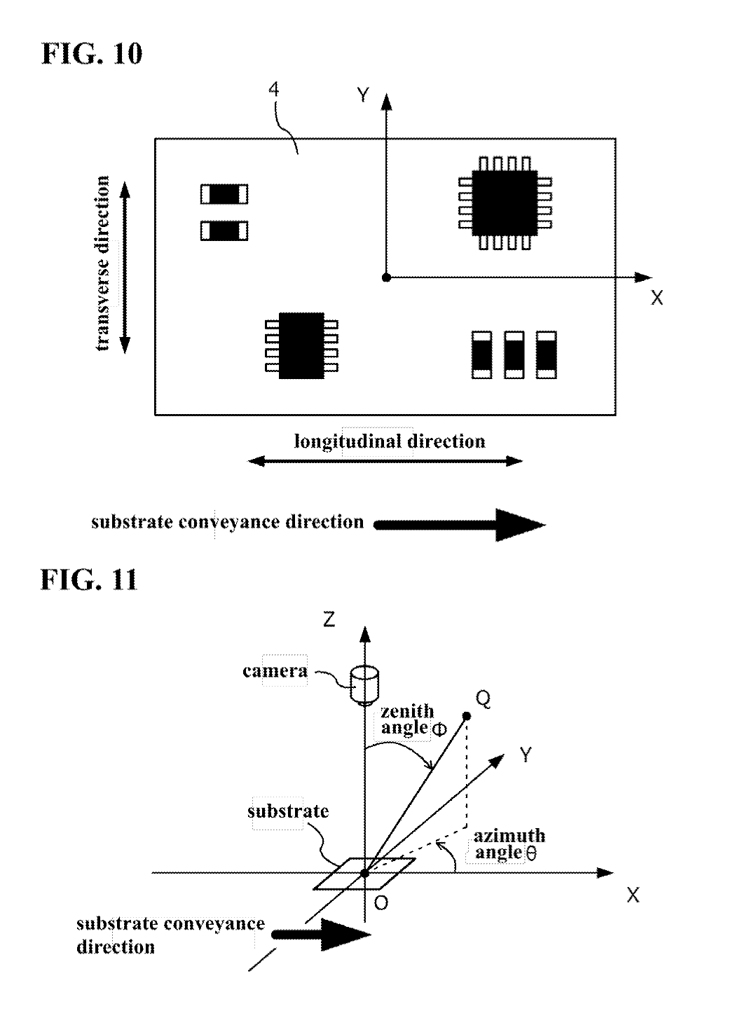

The inspection apparatus includes an illumination device 1, a camera 2, projection devices 3, a processing device P, and a conveying device (not shown). The illumination device 1 is a capable of illuminating a substrate 4 from all azimuth directions with illumination light for measuring the shape of solder, the illumination light changing stepwise or continuously depending on the zenith angle. The projection devices 3 serve as an illumination for measuring diffuse objects and are arranged such that they can project pattern light 3L from directions that are oblique with respect to the Z-axis (for example, from a zenith angle of 30 degrees) onto the substrate 4. The camera 2, which is arranged such that its optical axis coincides with the Z-axis, photographs the substrate 4 from the vertical direction and is used both for taking images for measuring solder shapes and for taking images for measuring diffuse objects. The processing device P is in charge of the processing for the control of the illumination device, the projection devices, the camera, the conveying device and the like, the analysis of the images taken by the camera, the inspection of solder joints, the measurement of component heights, and the output of inspection results. The conveying device is a device for conveying the substrate 4 to be inspected, and in the present embodiment, it introduces the substrate 4 from the negative X-axis side and after the measurement is finished, it conveys the substrate 4 to the positive X-axis side (see FIG. 10).

The illumination device 1 of the present embodiment is a dome-shaped illumination device that includes a light-source substrate in which blue LEDs 10B, green LEDs 10G and red LEDs 10R are arranged concentrically, and a dome-shaped diffuser panel 11. An opening 12 is provided at the vertex of the illumination device 1, and the camera 2 is positioned such that it can photograph the substrate 4 through the opening 12. Moreover, halfway up the illumination device 1, openings 13 for the projection devices are formed at an azimuth angle of about 45 degrees and an azimuth angle of about 225 degrees as viewed from the inspection position O. Thus, the pattern light 3L can be projected onto the substrate 4 through these openings 13 from the projection devices 3, which are arranged outside of the illumination device 1.

When a solder shape is measured, the illumination device 1 is turned on, and blue light 1B, green light 1G and red light 1R is irradiated from the respective light-emitting regions 11B, 11G and 11R of the diffuser panel 11. Thus, the light irradiated onto the substrate 4 from all azimuth directions changes from blue to green to red as the zenith angle increases (that is to say, light of the same color is irradiated onto the substrate 4 from corresponding (same) zenith angles φ for all azimuth angles θ=0 . . . 360 degrees). If the substrate 4 is photographed with this illumination, then the hue of the image of the solder portion will depend on the inclination angle. Thus, by analyzing the change of the hue, it is possible to derive e.g. the three-dimensional shape (the wetting height) of solder fillets.

To measure diffuse objects, it is possible to use phase shifts, light sectioning or other methods. In the case of using phase shifts, the substrate 4 is photographed multiple times while projecting striped pattern light from the projection devices 3 and changing the period of the striped pattern, and the three-dimensional shape (component height or the like) of the diffuse object can be derived from the change of the phase of the striped pattern. In the case of light sectioning, a line-shaped pattern light is projected, and the three-dimensional shape of the diffuse object is estimated from the deformations of the pattern light. It should be noted that the pattern light projected from the projection devices 3 is not limited to striped or line-shaped pattern light, and it is sufficient if it is light that is shaped to have a predetermined pattern or shape.

The following is an explanation of advantages of the inspection apparatus of the present embodiment. FIG. 10 is a plan view of the substrate surface taken from above, and it is assumed that the substrate 4 is conveyed to the right in FIG. 10. As shown in FIG. 10, almost all components that are surface-mounted on the substrate 4 are arranged parallel to the transverse direction or the longitudinal direction of the substrate 4. For this reason, the inclined surfaces of solder fillets are formed such that they point roughly in the X-axis direction or the Y-axis direction. Since in the present embodiment, the openings 13 for the projection devices are arranged at azimuth directions that differ from both the X-axis direction and the Y-axis direction, as shown in the cross-sectional view along AO in FIG. 1B, the light emitting region is continuous from the minimum zenith angle φmin (the zenith angle at the upper end of the blue light emitting region 11B in the present embodiment) to the maximum zenith angle φmax (the zenith angle at the lower end of the red light emitting region 11R in the present embodiment) at the four azimuth directions of the positive X-axis direction (0 degrees), the negative X-axis direction (180 degrees), the positive Y-axis direction (90 degrees), and the negative Y-axis direction (270 degrees), and there are no holes in the illumination light. Consequently, the influence that holes in the illumination light due to the openings 13 for the projection devices have on the measurement of the solder shape can be made sufficiently small, so that a stable shape measurement can be achieved.

It should be noted that as long as the azimuth directions of the openings 13 differ from the X-axis direction (0 degrees or 180 degrees) and the Y-axis direction (90 degrees or 270 degrees), the effect that the influence of the openings 13 is reduced can be attained, but it is most preferable if, as in the present embodiment, they are arranged near azimuth angles of 45 degrees+n×90 degrees (n=0, 1, 2, 3), which are the azimuth directions furthest away from the X-axis direction and the Y-axis direction, as then the influence of the openings 13 is minimized.

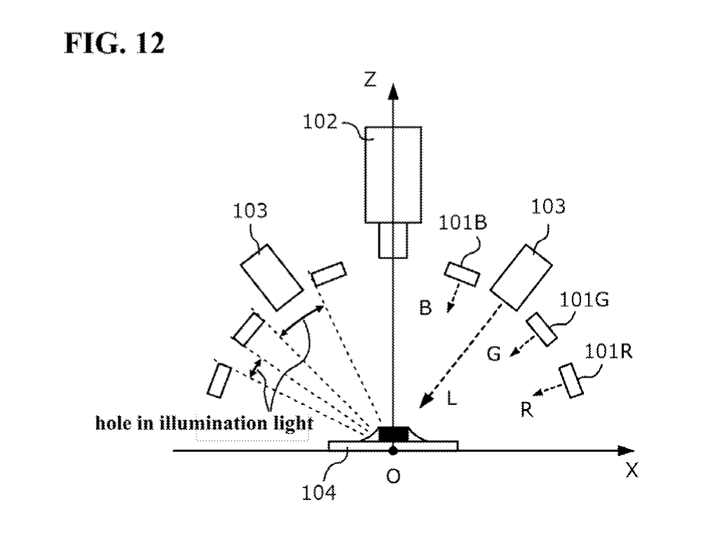

Moreover, if the openings 13 are arranged near azimuth angles of 45 degrees+n×90 degrees, there is also the advantage that substantially all measurement objects on the substrate can be covered by just two projection devices 3 that are arranged diagonally (at azimuth angles differing by 180 degrees) when seen from the inspection apparatus. That is to say, if the openings 13 are provided at about 45 degrees and 225 degrees as in the present embodiment, then then it is possible to illuminate three sides, namely the upper side, the side to the positive X-axis direction and the side to the positive Y-axis direction of the component with the pattern light illuminated from about 45 degrees, and to illuminate three sides, namely the upper side, the side to the negative X-axis direction and the side to the negative Y-axis direction of the component with the pattern light illuminated from about 225 degrees, so that the dead angles (regions that are not reached by the pattern light) can be reduced compared to the case that two projection devices 103 are disposed to the left and right in X-axis direction as in conventional devices (see FIG. 12).

### Second Embodiment

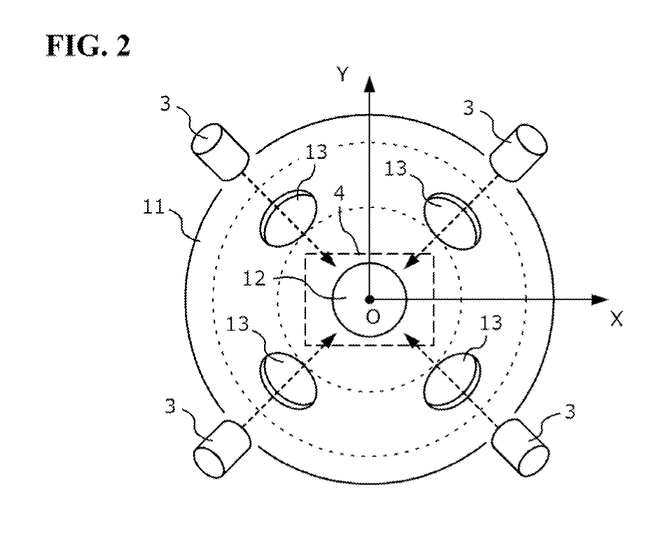

FIG. 2 is a diagram schematically showing the configuration of an inspection apparatus according to a second embodiment of the present invention. What is different to the first embodiment is that four projection devices 3 are provided, and the openings 13 for the projection devices are provided at the four azimuth angles of about 45 degrees, about 135 degrees, about 225 degrees and about 315 degrees. Also with this configuration, it is possible to attain a similar operational effect as with the first embodiment.

### Third Embodiment

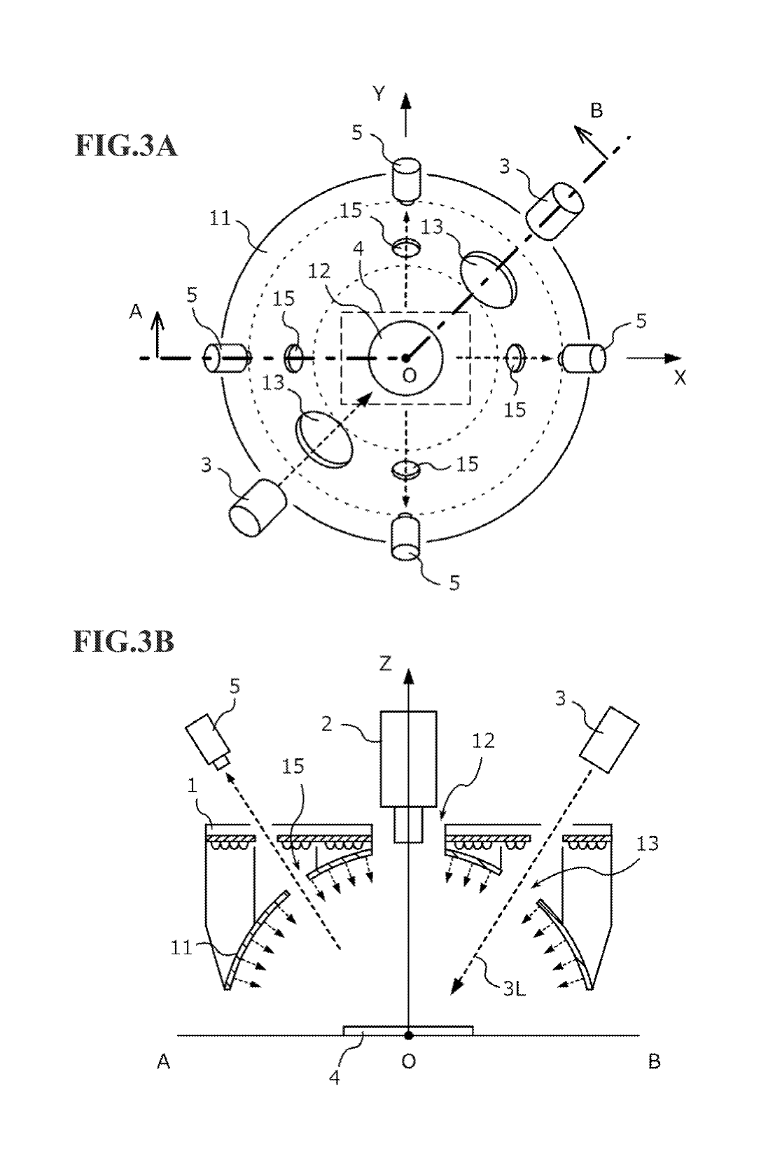

FIG. 3 A and FIG. 3B show diagrams schematically illustrating the configuration of an inspection apparatus according to a third embodiment of the present invention. FIG. 3A is a diagram illustrating the arrangement of the illumination device, projection devices and obliquely arranged cameras, as viewed from the Z-axis vertex. FIG. 3B is a combined cross-sectional view along the line AOB (dash-dotted line) in FIG. 3A. The following explanations relate only to aspects that are different from the first embodiment.

In addition to the structural elements of the first embodiment, the inspection apparatus includes four obliquely arranged cameras 5. The obliquely arranged cameras 5 are cameras for photographing the substrate 4 from directions that are oblique with respect to the Z-axis. The obliquely arranged cameras 5 can be used for the purpose of inspecting structures whose observation from directly above is difficult (for example, bridges or fillets of J-leads or the like), or for the purpose of three-dimensional measurements by stereo-photography. Also the obliquely arranged cameras 5 are preferably arranged obliquely with respect to the substrate 4, just like the projection devices 3, so that in the present embodiment, openings 15 for the obliquely arranged cameras are provided halfway up the illumination device 1. For this, the arrangement is such that the openings 13 for the projection devices and the openings 15 for the obliquely arranged cameras are arranged at different azimuth directions. The reason for this is that if two openings 13, 15 were arranged at the same azimuth direction and just spaced apart vertically, then the hole in the illumination light at that azimuth direction would be very large, risking that the precision with which the solder shape is measured is reduced considerably. More specifically, in the present embodiment, the two openings 13 for the projection devices are arranged at azimuth angles of about 45 degrees and about 225 degrees, and the four openings 15 for the obliquely arranged cameras are arranged at azimuth angles of about 0 degrees, about 90 degrees, about 180 degrees and about 270 degrees.

Also with the configuration explained above, it is possible to attain a similar operational effect as with the first embodiment. Now, with the configuration of the present embodiment, there are holes in the illumination light due to the openings 15 in the X-axis direction and the Y-axis direction, but as can be seen from the drawings, the openings 15 for the obliquely arranged cameras are smaller in size than the openings 13 for the projection devices, so that (compared to arranging the openings for the projection devices in the X-axis direction and the Y-axis direction as conventionally) the influence of the openings 15 is not much of a problem.

### Fourth Embodiment

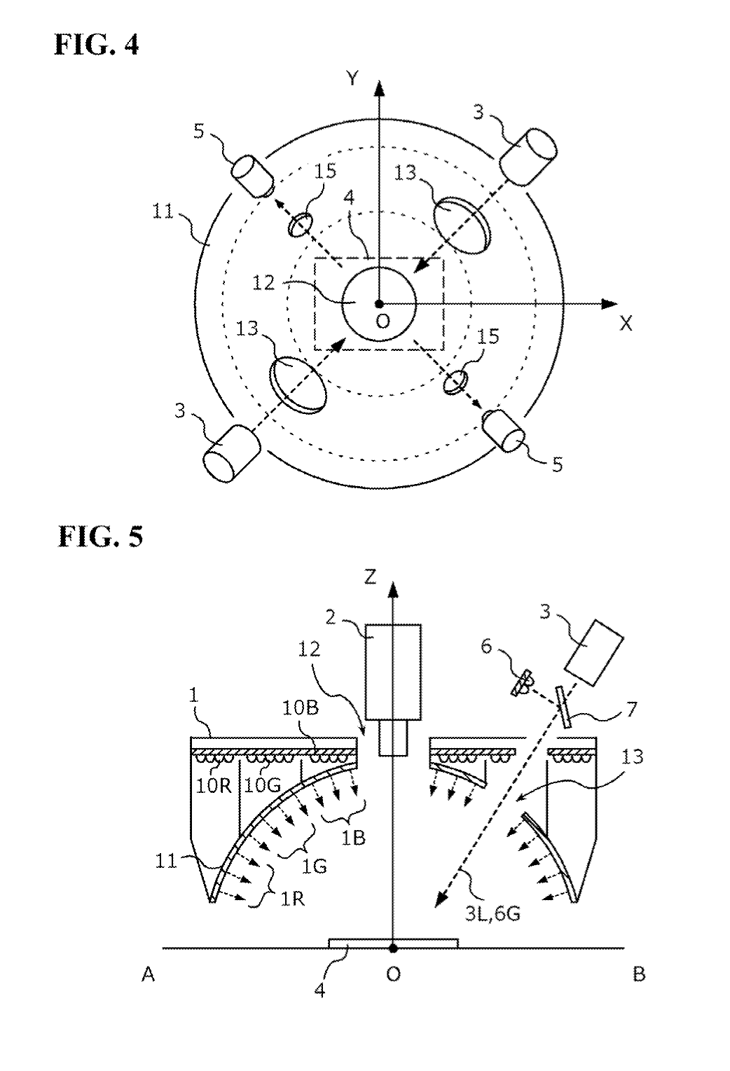

FIG. 4 is a diagram schematically illustrating the configuration of an inspection apparatus according to a fourth embodiment of the present invention. This embodiment differs from the third embodiment with regard to the aspects that there are two obliquely arranged cameras 5 and that the openings 15 for the obliquely arranged cameras are provided at the two azimuth angles of about 135 degrees and about 315 degrees. With this configuration, the holes in the illumination light in the X-axis direction and the Y-axis direction can be eliminated, so that the reliability of the measurement of the solder shape can be improved relative to that of the third embodiment.

### Fifth Embodiment

FIG. 5 is a diagram schematically illustrating the configuration of an inspection apparatus according to a fifth embodiment of the present invention. This fifth embodiment is a modification of the first embodiment or the second embodiment, and differs from these with regard to the aspect that each of the projection devices 3 is provided with a supplementary illumination device 6 and an optical member 7.

The supplementary illumination device 6 serves as an illumination that irradiates supplementary light 6G in order to supplement deficiencies in the illumination light that are caused by the openings 13 for the projection devices. In the present embodiment, the openings 13 for the projection devices are formed in the region for the green light 1G, so that the supplementary illumination device 6 is constituted by green LEDs that emit green supplementary light 6G. The optical member 7 is an optical system that matches the optical axis of the supplementary illumination device 6 with the optical axis of the projection device 3, and may be a half-mirror, for example.

When measuring a solder shape, both the illumination device 1 and the supplementary illumination device 6 are turned on and the supplementary light 6G is irradiated through the opening 13 onto the substrate 4, so that it is possible to realize an illumination that is substantially the same as if there were no opening 13. Consequently, with the present embodiment, it is possible to improve the reliability of the measurement of solder shapes beyond that of the above-noted embodiments.

### Sixth Embodiment

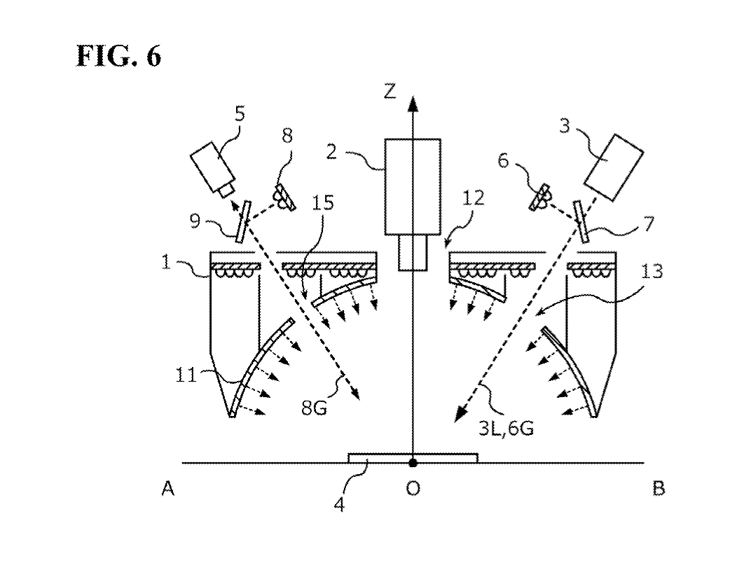

FIG. 6 is a diagram schematically illustrating the configuration of an inspection apparatus according to a sixth embodiment of the present invention. This sixth embodiment is a modification of the third embodiment, and differs from that with regard to the aspect that each of the projection devices 3 is combined with a supplementary illumination device 6 and an optical member 7, and that also each obliquely arranged camera 5 is combined with a supplementary illumination device 8 and an optical member 9. The supplementary illumination devices 6 and the optical members 7 for the projection devices are similar to those of the fifth embodiment, so that their further explanation is omitted.

The supplementary illumination device 8 serves as an illumination that irradiates supplementary light 8G in order to supplement deficiencies in the illumination light that are caused by the opening 15 for the obliquely arranged camera. In the present embodiment, the openings 15 for the obliquely arranged camera are formed in the region for the green light 1G, so that the supplementary illumination device 8 is constituted by green LEDs that emit green supplementary light 8G. The optical member 9 is an optical system that matches the optical axis of the supplementary illumination device 8 with the optical axis of the obliquely arranged camera 5, and may be a half-mirror, for example.

When measuring a solder shape, the illumination device 1, the supplementary illumination devices 6 and the supplementary illumination devices 8 are all turned on and the supplementary light 6G and 8G is irradiated through the openings 13 and 15 onto the substrate 4, so that it is possible to realize an illumination that is substantially the same as if there were no openings 13 or 15. Consequently, with the present embodiment, it is possible to improve the reliability of the measurement of solder shapes beyond that of the above-noted embodiments.

### Seventh Embodiment

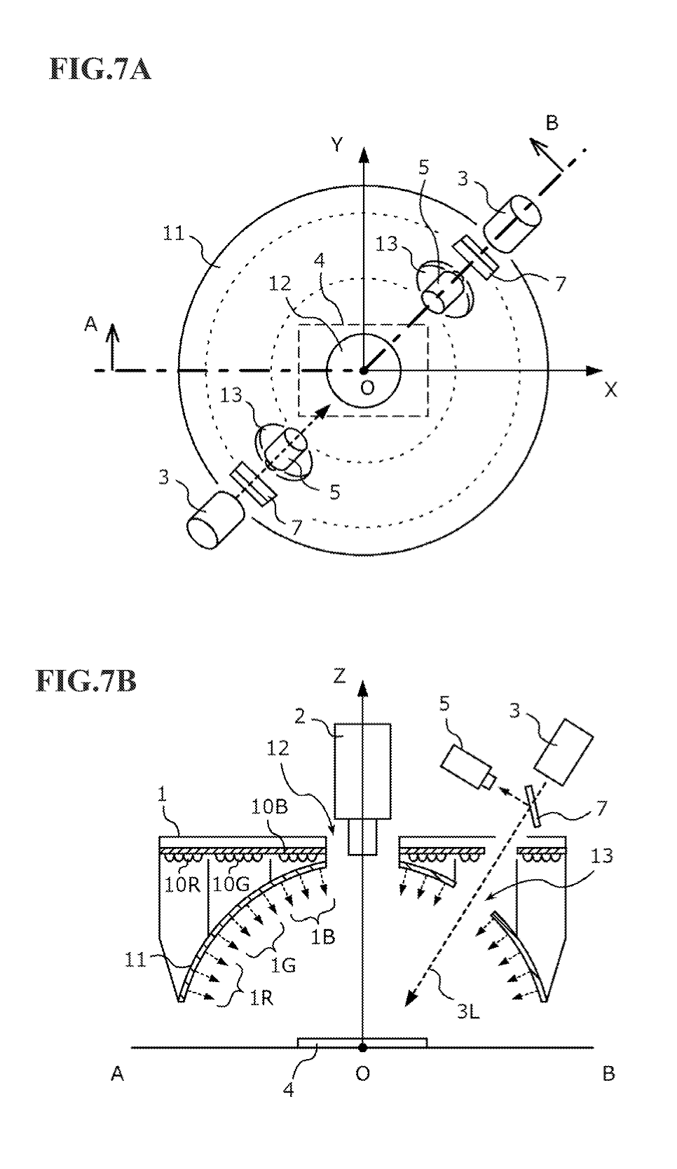

FIG. 7 A and FIG. 7 B show diagrams schematically illustrating the configuration of an inspection apparatus according to a seventh embodiment of the present invention. It is a feature of this seventh embodiment that the projection device 3 and the obliquely arranged camera 5 are combined into one unit.

As shown in FIG. 7B, the optical axis of the projection device 3 and the optical axis of the obliquely arranged camera are respectively matched by an optical member 7, such as a half-mirror, and the opening 13 for the projection device also serves as the opening for the obliquely arranged camera. Thus, by letting the projection device 3 and the obliquely arranged camera 5 share the same opening, the number of openings (area) with which the illumination device 1 is to be provided is reduced below that of the above-noted embodiments. Consequently, the holes in the illumination light due to the openings can be reduced, and the reliability of the measurement of solder shapes can be improved.

### Eighth Embodiment

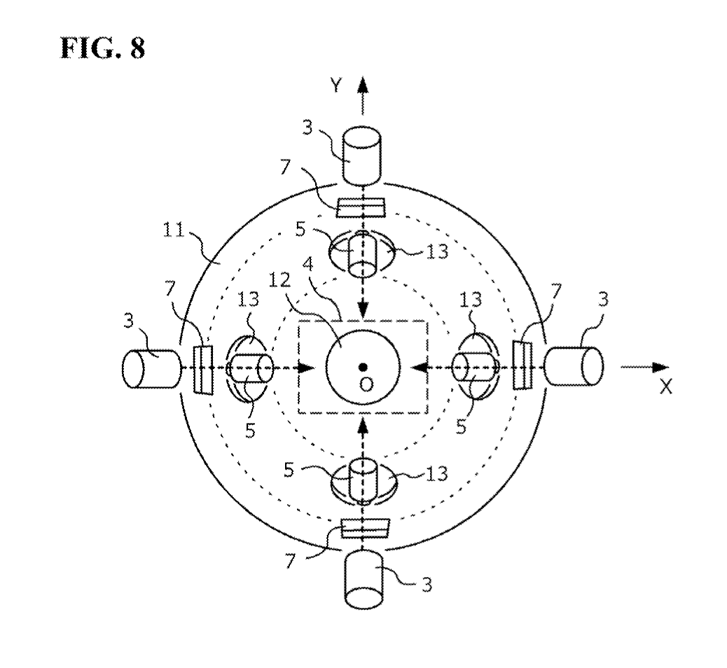

FIG. 8 is a diagram schematically illustrating the configuration of an inspection apparatus according to an eighth embodiment of the present invention. This eighth embodiment is a modification of the seventh embodiment, and differs from that with regard to the aspect that units of a projection device 3 and an obliquely arranged camera 5 arranged respectively in the positive direction of the X-axis, the negative direction of the X-axis, the positive direction of the Y-axis, and the negative direction of the Y-axis.

Also with the configuration of this embodiment, it is possible to attain a similar operational effect as with the seventh embodiment. Now, with the configuration of the present embodiment, there are holes in the illumination light due to the openings 13 in the X-axis direction and the Y-axis direction, but any single opening 13 serves both as an opening for a projection device and as an opening for an obliquely arranged camera, so that the effect can be attained that (compared to a configuration in which the opening for the projection device and the opening for the obliquely arranged camera are provided separately) the influence of the holes of the illumination light due to the openings 13 can be reduced.

### Ninth Embodiment

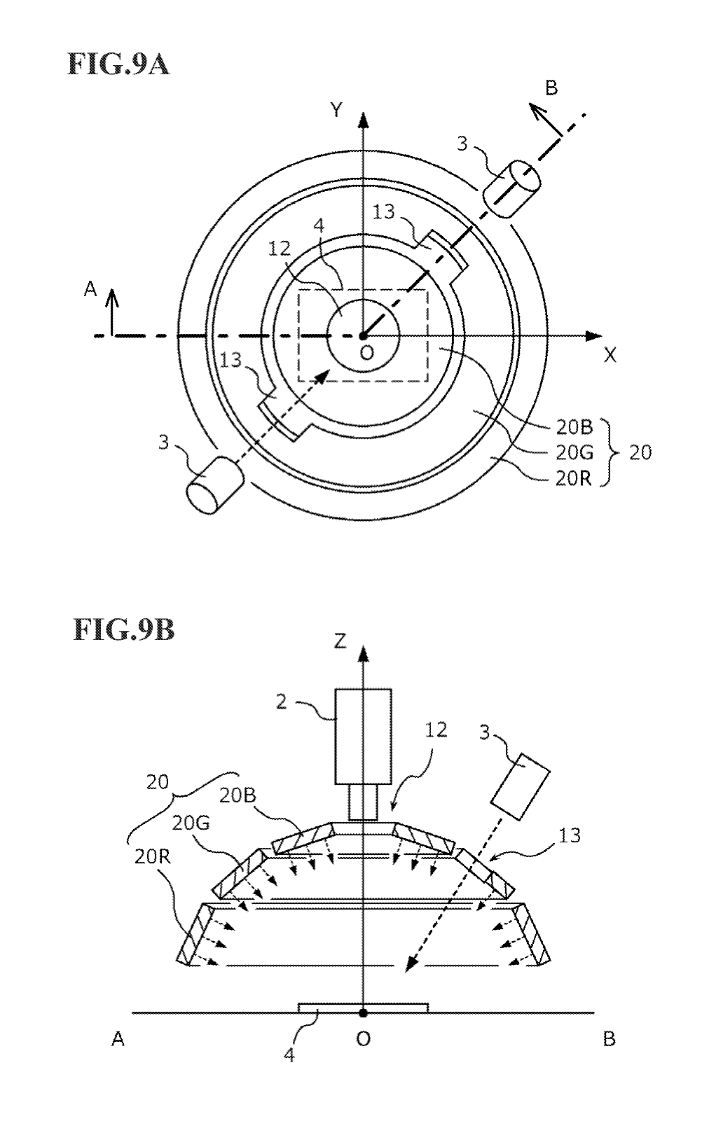

FIG. 9 A and FIG. 9 B are diagrams schematically illustrating the configuration of an inspection apparatus according to a ninth embodiment of the present invention. In the above-described embodiments, a dome-shaped illumination device 1 is used, whereas the present embodiment differs with regard to the aspect that an illumination device 20 is used that is constituted by a plurality of light-emitting bodies 20B, 20G, 20R of different colors.

The light-emitting body 20B serves as a ring-shaped illumination emitting blue light, and can be manufactured for example by arranging an array of blue LEDs on a ring-shaped substrate. The light-emitting body 20G serves as a ring-shaped illumination emitting green light, and the light-emitting body 20R serves as a ring-shaped illumination emitting red light. The light-emitting body 20G and the light-emitting body 20R can be manufactured in the same manner as the light-emitting body 20B. By arranging these three light-emitting bodies 20B, 20G and 20R at different zenith angles, it is possible to irradiate similar illumination light as with the above-described dome-shaped illumination device 1.

In the present embodiment, pattern light is projected onto the substrate 4 from projection devices 3 that are arranged outside the illumination device 20, so that openings 13 for the projection devices are formed in portions of the light-emitting body 20G. Also in this case, by letting the azimuth directions of the openings 13 differ from both the X-axis direction and the Y-axis direction, it is possible to achieve a similar operational effect as described for the first embodiment. Now, in order to reduce the holes in the illumination light to a minimum and to increase the reliability of the measurement of solder shapes, it is possible to line up the light-emitting bodies without gaps between them at all portions besides the openings 13 (the gaps may be eliminated entirely or reduced to be sufficiently small so that they have no influence on the measurement of the solder shapes).

### <Further Considerations>

The above embodiments are just to illustrate exemplary embodiments of the present invention, and the present invention is not limited to these embodiments. Various modifications within the technical scope of the invention are possible. For example, as long as no technical contradiction occurs, the configurations of the above embodiments may be combined. Furthermore, the projection devices 3 of the first embodiment and the second embodiment may be replaced by obliquely arranged cameras 5. That is to say, in configurations including an illumination device 1, a camera 2 and an obliquely arranged camera 5, the opening for the obliquely arranged camera is arranged at an azimuth direction that is different from the X-axis direction and the Y-axis direction.

Moreover, illumination with three colors was used as the illumination device for measuring solder shapes, but it is also possible to use illumination with two colors or four or more colors. Furthermore, instead of an illumination in which the color changes step-wise, it is also possible to use an illumination in which the color changes continuously. Alternatively, it is also possible to use an illumination in which the brightness, and not the color, changes step-wise or continuously.

### LIST OF REFERENCE NUMERALS

1: illumination device
1R: red light
1G: green light
1B: blue light
10R: red LED
10G: green LED
10B: blue LED
11: diffuser plate
11R, 11G, 11B: light-emitting region
2: camera
12: opening for camera
3: projection device
3L: pattern light
13: opening for projection device
4: substrate
5: obliquely arranged camera
15: opening for obliquely arranged camera
6: supplementary illumination device
6G: supplementary light
7: optical member
8: supplementary illumination device
8G: supplementary light
9: optical member
20: illumination device
20R, 20G, 20B: light-emitting body
O: inspection position
P: processing device

What is claimed is:

1. An inspection apparatus having a camera for photographing a substrate onto which components are soldered from a direction orthogonal thereto,
wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises:
an illumination device that is configured to illuminate the substrate from all azimuth directions with illumination light whose color or brightness changes stepwise or continuously depending on the zenith angle;
one or more projection devices that are configured to project pattern light onto the substrate from a direction that is oblique with respect to the Z-axis; and
a processing device that is configured to perform an inspection using an image of the substrate that is photographed with the camera in a state in which the illumination device is turned on or in a state in which pattern light is projected from the one or more projection devices;
the one or more projection devices projecting the pattern light onto the substrate through one or more openings that are provided in the illumination device; and
the one or more openings being provided at one or more azimuth directions that are different from both the X-axis direction and the Y-axis direction, as viewed from the point of origin.

2. The inspection apparatus according to claim 1,
wherein the illumination device has a dome-shaped light-emitting region;
at least in the four azimuth directions of the positive X-axis direction, the negative X-axis direction, the positive Y-axis direction, and the negative Y-axis direction, the light-emitting region is continuous from the smallest zenith angle to the largest zenith angle.

3. The inspection apparatus according to claim 1,
wherein the illumination device comprises a plurality of light-emitting bodies with different hue or brightness that are arranged at different zenith angles,
at least in the four azimuth directions of the positive X-axis direction, the negative X-axis direction, the positive Y-axis direction, and the negative Y-axis direction, the plurality of light-emitting bodies are lined up with substantially no gap between them.

4. The inspection apparatus according to claim 1,
wherein, taking an azimuth angle of the positive X-axis direction as 0 degrees, the one or more openings are provided at about 45 degrees, about 135 degrees, about 225 degrees and/or about 315 degrees, viewed from the point of origin.

5. The inspection apparatus according to claim 1,
wherein the inspection apparatus includes two projection devices; and
an opening for one of the projection devices and an opening for the other of the projection devices are arranged at azimuth directions that differ by 180 degrees, viewed from the point of origin.

6. The inspection apparatus according to claim 1,
further comprising one or more obliquely arranged cameras that are configured to photograph the substrate through one or more openings in the illumination device from one or more directions that are oblique with respect to the Z-axis.

7. The inspection apparatus according to claim 6,
wherein the openings for the one or more projection devices and the openings for the one or more obliquely arranged cameras are at different azimuth directions, viewed from the point of origin.

8. The inspection apparatus according to claim 6,
further comprising an optical member that is configured to match respective optical axes of the one or more projection devices with respective optical axes of the one or more obliquely arranged cameras,
the openings for the one or more projection devices also serving as the openings for the one or more obliquely arranged cameras.

9. The inspection apparatus according to claim 1,
further comprising a supplementary illumination device that irradiates the substrate with supplementary light that supplements deficiencies of the illumination light due to the one or more openings in the illumination device.

10. An inspection apparatus having a camera for photographing a substrate onto which components are soldered from a direction orthogonal thereto,
wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises:
an illumination device that is configured to illuminate the substrate from all azimuth directions with illumination light whose color or brightness changes stepwise or continuously depending on the zenith angle;
one or more projection devices that are configured to project through one or more openings in the illumination device pattern light onto the substrate from one or more directions that are oblique with respect to the Z-axis;
a supplementary illumination device that irradiates the substrate with supplementary light that supplements deficiencies of the illumination light due to the one or more openings in the illumination device; and
a processing device that is configured to perform an inspection using an image of the substrate that is photographed with the camera in a state in which the illumination device and the supplementary illumination device are turned on or in a state in which pattern light is projected from the one or more projection devices.

11. An inspection apparatus having a camera for photographing a substrate onto which components are soldered from a direction orthogonal thereto,
wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises:
an illumination device that is configured to illuminate the substrate from all azimuth directions with illumination light whose color or brightness changes stepwise or continuously depending on the zenith angle;
one or more projection devices that are configured to project through one or more openings in the illumination device pattern light onto the substrate from one or more directions that are oblique with respect to the Z-axis;
one or more obliquely arranged cameras that are configured to photograph the substrate through one or more openings in the illumination device from one or more directions that are oblique with respect to the Z-axis; and
a processing device that is configured to perform an inspection using an image of the substrate that is photographed with the camera in a state in which the illumination device is turned on or in a state in which pattern light is projected from the one or more projection devices or an image of the substrate that is photographed with the one or more obliquely arranged cameras in a state in which the illumination device is turned on,
the one or more openings for the projection devices being arranged at different azimuth directions, as viewed from the point of origin, from azimuth directions of the one or more openings for the obliquely arranged cameras.

12. An inspection apparatus having a camera for photographing a substrate onto which components are soldered from a direction orthogonal thereto,
wherein, taking an intersection of an optical axis of the camera with a substrate conveyed into the inspection apparatus as a point of origin, taking a direction that is parallel to a substrate surface and parallel to a conveyance direction of the substrate as an X-axis, taking a direction that is parallel to the substrate surface and orthogonal to the conveyance direction of the substrate as a Y-axis, taking a direction that is orthogonal to the substrate surface as a Z-axis, taking an angle with respect to the Z-axis as a zenith angle, and taking a direction from the point of origin and within the XY-plane as an azimuth direction, the inspection apparatus comprises:
an illumination device that is configured to illuminate the substrate from all azimuth directions with illumination light whose color or brightness changes stepwise or continuously depending on the zenith angle;
one or more projection devices that are configured to project through one or more openings in the illumination device pattern light onto the substrate from one or more directions that are oblique with respect to the Z-axis;
one or more obliquely arranged cameras that are configured to photograph the substrate through one or more openings in the illumination device from one or more directions that are oblique with respect to the Z-axis;
a processing device that is configured to perform an inspection using an image of the substrate that is photographed with the camera in a state in which the illumination device is turned on or in a state in which pattern light is projected from the one or more projection devices or an image of the substrate that is photographed with the one or more obliquely arranged cameras in a state in which the illumination device is turned on; and
an optical member that is configured to match respective optical axes of the one or more projection devices with respective optical axes of the one or more obliquely arranged cameras,
the openings for the one or more projection devices also serving as the openings for the one or more obliquely arranged cameras.
